(19) United States
(12) Patent Application Publication
(10) Pub. No.: US 2021/0342838 A1
(43) Pub. Date: Nov. 4, 2021

(54) SYSTEMS AND METHODS FOR RECEIVING AND DISTRIBUTING CONSIDERATION VIA SMART CONTRACTS ON A BLOCKCHAIN

(71) Applicant: Tokencard Limited, Manchester (GB)

(72) Inventors: David James HOGGARD, Kent (GB); Mel-Rob GELDERMAN, Hall (NL)

(73) Assignee: Tokencard Limited, Manchester (GB)

(21) Appl. No.: 17/372,856

(22) Filed: Jul. 12, 2021

Related U.S. Application Data
(62) Division of application No. 15/912,240, filed on Mar. 5, 2018.
(60) Provisional application No. 62/487,967, filed on Apr. 20, 2017.

(51) Int. Cl. G06Q 20/40; G06Q 20/38; G06Q 20/34; H04L 9/06; G06Q 20/10; G06Q 20/36; H04L 29/08

(52) U.S. Cl. CPC G06Q 20/405; G06Q 20/3829; G06Q 20/34; H04L 67/104; G06Q 20/102; G06Q 20/36; H04L 9/0637

(57) ABSTRACT

Systems and methods for receiving and distributing consideration via smart contracts on a blockchain, the method being implemented by a computer system including one or more processors configured by machine-readable instructions are disclosed. Exemplary implementations may: receive a spend request responsive to a user initiating payment via a debit card; obtain contract information for the contract wallet on the blockchain associated with the debit card; determine whether or not to authorize the spend request based on the rules and the balance of the stored consideration; and responsive to a determination that the spend request should be authorized, initiate a withdrawal of the amount of consideration for the spend request from the contract wallet.

### CROSS-REFERENCE TO RELATED APPLICATIONS

This application is a division of U.S. patent application Ser. No. 15/912,240, filed Mar. 5, 2018, entitled “SYSTEMS AND METHODS FOR RECEIVING AND DISTRIBUTING CONSIDERATION VIA SMART CONTRACTS ON A BLOCKCHAIN”, which claims the benefit of U.S. Provisional Patent Application Ser. No. 62/487,967, filed Apr. 20, 2017, entitled “SYSTEMS AND METHODS FOR RECEIVING AND DISTRIBUTING CONSIDERATION VIA SMART CONTRACTS ON A BLOCKCHAIN”, which are hereby incorporated by reference in their entirety.

### FIELD OF THE DISCLOSURE

The present disclosure relates to systems and methods for receiving and distributing consideration via smart contracts on a blockchain, the method being implemented by a computer system including one or more processors configured by machine-readable instructions.

### BACKGROUND

Blockchain technology uses the blockchain, otherwise known as a distributed ledger, a public ledger, a transaction database, and/or by other terms, to create a publicly verifiable record of digital transactions. Digital transactions may include cryptocurrency transactions, smart contract transactions, and/or other similar digital transactions.

### SUMMARY

One aspect of the present disclosure relates to a system configured for receiving and distributing consideration via smart contracts on a blockchain, the method being implemented by a computer system including one or more processors configured by machine-readable instructions. The system may include one or more hardware processors configured by machine-readable instructions. The processor(s) may be configured to receive a spend request responsive to a user initiating payment via a debit card. The spend request may include an amount of consideration to be spent, a type of the consideration to be spent, a card identifier identifying the debit card and a contract wallet on the blockchain associated with the debit card, and/or other information. The contract wallet may include stored consideration and/or a smart contract having rules that control access to the stored consideration. The processor(s) may be configured to obtain contract information for the contract wallet on the blockchain associated with the debit card. The contract information may include the rules that control the access to the stored consideration included in the contract wallet, a balance of the stored consideration within the contract wallet, and/or other information. The processor(s) may be configured to determine whether or not to authorize the spend request based on the rules, the balance of the stored consideration, and/or other information. The processor(s) may be configured to, responsive to a determination that the spend request should be authorized, initiate a withdrawal of the amount of consideration for the spend request from the contract wallet.

Another aspect of the present disclosure relates to a method for receiving and distributing consideration via smart contracts on a blockchain, the method being implemented by a computer system including one or more processors configured by machine-readable instructions. The method may include receiving a spend request responsive to a user initiating payment via a debit card. The spend request may include an amount of consideration to be spent, a type of the consideration to be spent, and a card identifier identifying the debit card and a contract wallet on the blockchain associated with the debit card. The contract wallet may include stored consideration and a smart contract having rules that control access to the stored consideration. The method may include obtaining contract information for the contract wallet on the blockchain associated with the debit card. The contract information may include the rules that control the access to the stored consideration included in the contract wallet, and a balance of the stored consideration within the contract wallet. The method may include determining whether or not to authorize the spend request based on the rules and the balance of the stored consideration. The method may include, responsive to a determination that the spend request should be authorized, initiating a withdrawal of the amount of consideration for the spend request from the contract wallet.

One aspect of the present disclosure relates to a system configured for providing limited access to stored consideration within contract wallets associated with users via smart contracts on a blockchain, the method being implemented via one or more physical processors configured by machine-readable instructions. The system may include one or more hardware processors configured by machine-readable instructions. The processor(s) may be configured to receive a user request to create a user account. The user request may include user information for establishing a contract wallet associated with the user that includes a smart contract and stored consideration. The processor(s) may be configured to generate a full private key for the user account that facilitates access to first level options for the contract wallet and/or the stored consideration within the contract wallet.

The processor(s) may be configured to receive user input defining rules for a smart contract that control the system's access to the stored consideration within the contract wallet. The processor(s) may be configured to generate a smart contract on the blockchain between the user and the system based on the user input defining the rules. The smart contract may govern the limited access to the stored consideration within the contract wallet associated with the user by the system.

Another aspect of the present disclosure relates to a method for providing limited access to stored consideration within contract wallets associated with users via smart contracts on a blockchain, the method being implemented via one or more physical processors configured by machine-readable instructions. The method may include receiving a user request to create a user account. The user request may include user information for establishing a contract wallet associated with the user that includes a smart contract and stored consideration. The method may include generating a full private key for the user account that facilitates access to first level options for the contract wallet and/or the stored consideration within the contract wallet. The method may include receiving user input defining rules for a smart contract that control the system's access to the stored consideration within the contract wallet. The method may include generating a smart contract on the blockchain between the user and the system based on the user input defining the rules. The smart contract may govern the limited access to the stored consideration within the contract wallet associated with the user by the system.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured for receiving and distributing consideration via smart contracts on a blockchain, in accordance with one or more implementations.

FIG. 2 illustrates a method for receiving and distributing consideration via smart contracts on a blockchain, in accordance with one or more implementations.

FIG. 3 illustrates a method for providing limited access to stored consideration within contract wallets associated with users via smart contracts on a blockchain, in accordance with one or more implementations.

### DETAILED DESCRIPTION

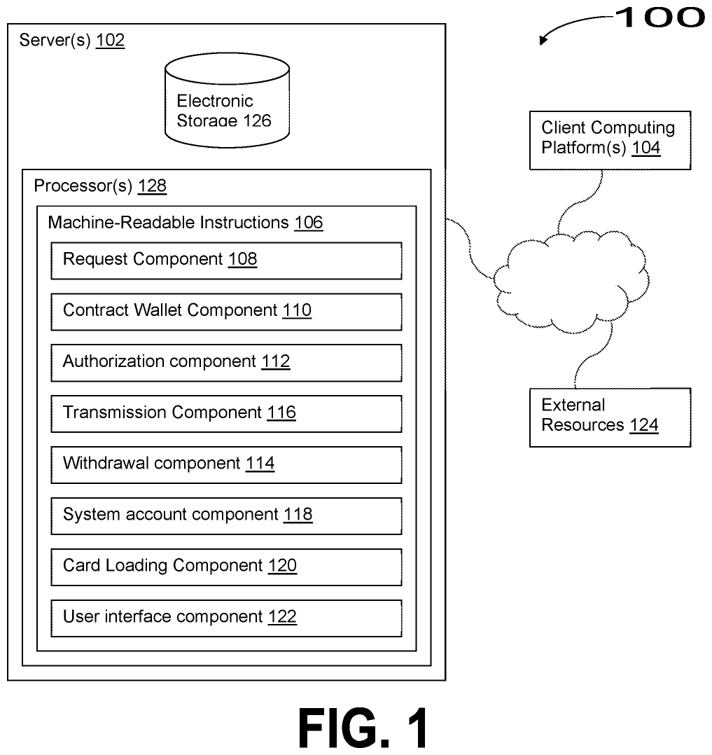

FIG. 1 illustrates a system 100 configured for receiving and distributing consideration via smart contracts on a blockchain, the method being implemented by a computer system including one or more processors configured by machine-readable instructions, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction components. The instruction components may include computer program components. The instruction components may include one or more of a request component 108, a contract wallet component 110, an authorization component 112, a transmission component 114, withdrawal component 116, a system account component 118, a card loading component 120, a user interface component 122, and/or other instruction components.

Request component 108 may be configured to receive a spend request responsive to a user initiating payment via a debit card. In some implementations, the spend request may include other types of requests (e.g., a refund request, investment request, and/or other requests). The spend request may be received from a debit network. The debit card may be a physical debit card used to make a purchase which initiates the spend request. By way of non-limiting example, the spend request may include an amount of consideration to be spent, a type of the consideration to be spent, a card identifier identifying the debit card, a contract wallet on the blockchain associated with the debit card, and/or other information. The type of consideration to be spent may include a denomination of currency to be spent. For example, the type of consideration to be spent may include one or more of a crypto currency, a decentralized currency, and/or centralized currency. Throughout this description the terms “consideration” and “asset(s)” may be used interchangeably.

The card identifier may include information identifying the contract wallet. The contract wallet may include a smart contract wallet. The smart contract wallet may hold and/or store consideration (e.g., a record of consideration, crypto currency information (e.g., private keys, etc.). The contract wallet may be associated with a specific debit card having a specific card identifier. In some implementations, the contract wallet may be associated with multiple debit cards having different card identifiers. By way of non-limiting example, the physical debit card may be associated with the card identifier, the contract wallet on the blockchain, and/or the smart contract on the blockchain.

The contract wallet on the blockchain may be associated with a public key corresponding to one or more of the full private keys and/or partial private keys held by one or more users, one or more system providers (e.g., a third-party and/or third-party platform, etc.) and/or others. The type of private key a given user, platform, system, and/or device has may indicate how much control and/or access the user, platform, system, and or device has to the contract wallet and the rules included in the smart contract of the contract wallet. The contract wallet may include stored consideration and a smart contract having rules that control access to the stored consideration. The stored consideration may include crypto currency. The contract wallet may include a smart crypto currency wallet on the blockchain. The computer system performing the method and/or a system provider associated with the computer system (e.g., system 100) may be provided limited access to the contract wallet to withdraw and/or sell at least a portion of the consideration in accordance with the rules included in the smart contract.

By way of non-limiting example, the contract wallet may be associated with one or more cryptographic keys used to access, control, and/or manage the rules of the smart contract included in the contract wallet and/or the stored consideration. Managing the smart contract may include establishing and/or updating the rules that control access to the stored consideration and/or the contract wallet. The one or more cryptographic keys may include one or more full private keys and/or one or more partial private keys that provide access to varying of options for managing and/or accessing the contract wallet and/or the stored consideration. The full private keys may include a user private key that facilitates access to first level options for contract wallet. The full private keys may facilitate access to first level options and/or limited options for the contract wallet. By way of non-limiting example, the first level options may include one or more of: establishing, modifying, and/or updating of one or more of the rules of the smart contract included in the contract wallet, and/or other options. The limited options may include one or more of: withdrawing, spending, transferring, and/or selling the stored consideration; initiating an emergency drain of the stored consideration; monitoring transactions associated with the contract wallet, and/or other features. In some implementations, the user private key may facilitate access to one or more options for the contract wallet that one or more of the full private keys does not facilitate access to. The full private keys may facilitate access to one or more options for the contract wallet that one or more of the partial private keys does not facilitate access to. As such, by way of non-limiting example, a user may have access to options for the contract wallet that are only available to the user, certain users, and/or not to other users. The user may customize and/or determine accessibility options that should be provided to individual users, parties, third party-platforms, the system provider, etc. via the determining and/or modifying the rules and/or requesting/providing one or more full private keys and/or partial private keys to the individual users, parties, third party-platforms, the system provider, etc.

The one or more partial private keys may facilitate access to limited options for the contract wallet. By way of non-limiting example, the limited options may include one or more of withdrawing, spending, transferring, and/or selling the stored consideration, initiating an emergency drain of the stored consideration, and/or monitoring transactions associated with the contract wallet.

Contract wallet holders may attach specific allowances or other rules to multiple cards. These could have many features: from family budget management to expense account reimbursement rules. Watch-only accounts may be set up to monitor expenses. In some implementations, different debit cards may be governed by specific rules included in the smart contract of the contract wallet. The different card identifiers may indicate which of the rules included in the smart contract apply to which individual ones of the multiple debit cards.

Contract wallet component 110 may be configured to obtain contract information for the contract wallet on the blockchain associated with the debit card. By way of non-limiting example, the contract information may include the rules that control the access to the stored consideration included in the contract wallet, and a balance of the stored consideration within the contract wallet. The rules may control how much of the consideration included in a contract wallet a third party platform (facilitating the transaction via the debit card, the debit network, and/or the blockchain) can withdraw from the users contract wallet (e.g., in accordance with the rules), and how and/or when the consideration may be withdrawn and/or spent.

The rules that may control access to the stored consideration further include rules that control a spending mode for the stored consideration within the contract wallet. By way of non-limiting example, the spending mode may include one or more of single asset spending, multi asset spending, portfolio spending, tax neutral spending, price slippage limit spending, and/or liquid assets spending. As such, a transaction resulting from the spend request, may be made according to the spending mode indicated by the rules. A user may determine, modify, establish, and/or change the spending mode via accessing, modifying, establishing, and or changing the rules included in the smart contract of the contract wallet.

Single asset spending may include spending a single asset selected to be made available to be spent via the system via the rules. Other assets (e.g., types of consideration, etc.) may be added to a queue to give an order of priority in which assets should be spent. Multi asset spending may include spending multiple assets at a time and/or in response to a given spend request. A user may select multiple different assets (e.g., types of consideration, etc.) and/or a percentage that should be allocated to individual assets (via the rules) such that payments are distributed between the assets according to the percentages. In some implementations, if the users paying with illiquid assets, multi asset spending may improve liquidity and make spending more efficient. A user has set up his TokenCard to pay with 50% ETH, 30% REP and 20% DGX. When he pays for a $500 utility bill, the equivalent of $250 of ETH, $150 of REP and $100 of DGX are withdrawn simultaneously from his Contract Wallet. Portfolio spending may include spending based on a Fiat weighting of assets. For example a user may determine and or give target portfolio weightings via the rules, and withdraws may be optimized by the system to maintain the user given weightings according to the rules. For example, a user targets a portfolio value of 20% DGX and 80% ETH. Recently the value of DGX has gone up and now represents a larger percentage of the portfolio. This means a card swipe will now withdraw proportionally more DGX to bring the percentage closer to the set target. Users may determine and/or set other rules to enable and/or obtain tax neutral spending, price slippage limit spending, and/or liquid assets spending.

By way of non-limiting example, the rules that may control access to the stored consideration further include one or more of a user withdrawal limit, third-party allowance, an emergency drain, an inactivity drain, a card block, and/or a withdrawal whitelist. A user withdrawal limit may include rules a user establishes via the smart contract to control and/or limit their own spending. The user withdrawal limit may include one or more of a Fiat/token denominated withdrawal limit (e.g., an amount of consideration withdrawal limit), a percentage based withdrawal limit (e.g., a percentage of total consideration stored in the contract wallet that a user may spend), a time-based withdrawal limit (e.g., indicating that transactions for specified period of time should be approved and/or allowed, and/or transactions at a specific frequency should not be approved or allowed, etc.), and/or other time-based withdrawal limits.

The third-party allowance may include smart contract enforced parameters that give the user fine-grained control over a third-party's (e.g., the system's) access to their funds (e.g., consideration). The rules of the contract wallet (e.g., the smart contract of the contract wallet) may dictate exactly how much a third party platform (e.g., the system) can withdraw from their contract wallet. For example, a user could potentially have a billion dollars-worth of ETH and tokens in their contract wallet, but the third-party platform (e.g., the system provider) could only ever withdraw up to 2000 USD worth of the tokens per day if the user defined the contracts rules as such. Therefore, a spend request for over 2000 USD worth of the tokens would be denied by system 100 because the rules indicate it is more than the third-party allowance. The third-party allowance may include one or more of a daily Fiat limit (e.g., a fixed value or worth allowed), a daily limit (e.g., a fixed number of tokens allowed), a percentage limit (e.g., a percentage of the consideration in the contract wallet), a time-based limit (e.g., withdrawals may be allowed for a specific amount of time, and/or up to a specific frequency), and/or other limits. The third-party allowances and/or limits are not mutually exclusive such that a daily Fiat limit and time-based limit may be implemented to ensure that the third-party platform is allowed to make large $10 k spends for one hour.

An emergency drain may send the entire balance of a contract wallet to a predefined address or a newly published backup contract wallet. An emergency drain may be called by one or more users and/or the third-party platform/system provider (e.g., having a partial private key), and/or one or more users having a full private key. The backup contract wallet may have a time delay for third-party platform (e.g., system provider) access. As such, everything keeps working because funds are now in the backup contract wallet and the card changes its associated contract wallet in the database. By way of non-limiting example, a user with poor personal security has lost access to his contract wallet. It is now controlled by a malicious third party. Limits on his own side (via the rules of the smart contract) prevent the third party from withdrawing more than $100 per day. He contacts the system and/or system provider (e.g., a third party platform) to initiate an emergency contract migration to a predefined fresh contract wallet that the user controls (e.g., has the full private key to). The system and/or debit card remains functional throughout the process, and the user has minimized losses.

Inactivity drain may include if the user dies, an activity timer may be triggered and or the consideration stored and contract wallet with drawn to a pre-specified address. As such, for example after 6 months' inactivity, all funds and/or consideration stored within a given contract wallet may be sent to a family member and/or a lawyer owned multisig.

Card block may be called in the case of lost or stolen card. A card block may cause a system and/or third-party to stop allowing transactions. The card block may include a refund feature.

A whitelist may contain one or more addresses to which a user wishes to permit a withdrawal to be directed. When a whitelist is present, requests for withdrawals to addresses not on the whitelist may be denied. In this case, even if a user loses access to their contract wallet, a malicious third party may only withdraw funds to addresses specified in the whitelist, thus providing a thorough extra layer of security within the contract wallet, were it to be compromised.

Authorization component 112 may be configured to determine whether or not to authorize the spend request based on the rules and the balance of the stored consideration. Determining whether or not to authorize the spend request based on the rules and the balance of stored consideration may include determining whether there is enough balance included in a contract wallet to cover the amount of consideration to be spent for a given spend request, determining whether the rules enable the third-party platform and/or system to have access to and/or withdraw the amount of consideration to be spent for the given spend request, and/or determining how to spend and/or withdraw the amount of consideration to be spent for the given spend request according to the rules.

Transmission component 114 may be configured to transmit authorization for the spend request to the debit network (e.g., Visa, Mastercard, etc.) responsive to the determination that the spend request should be authorized.

In some implementations, system 100 may be associated with an account. The accounts may be associated with a system provider (e.g., a third party platform provider) and/or include a value of stored consideration associated with system. The account may be associated with one or more of the debit networks such that consideration is transmitted from the account to one or more of the debit networks in response to the spend request being authorized.

By way of non-limiting example, contract wallets may store the balances of users consideration. The debit cards may be effectively “empty” up until the moment they are used (e.g., a 0-balance method). System 100 may load the debit cards before it can allow transactions though them. The debit cards may be loaded via the value of stored consideration in the account associated with the system provider.

System account component 118 may be configured to dynamically update the value of the stored consideration included in the account. By way of non-limiting example, the account may be dynamically updated with a set amount of consideration per interval of time, and/or with other amounts of consideration at one or more times. In some implementations, the account may be dynamically updated based on past spend requests received from a debit network. The debit network may be associated with a debit and/or credit partner. Transmission component 114 may be configured to, responsive to the determination that the spend request should be authorized, transmit authorization information to the debit network approving the spend request.

Card loading component 120 may be configured to load the debit card with the amount of consideration for the spend request by deducting the amount of consideration for the spend request from the account associated with the system provider.

Withdrawal component 116 may be configured to, responsive to a determination that the spend request should be authorized, initiate a withdrawal of the amount of consideration for the spend request from the contract wallet. The withdrawal may be initiated and completed via the blockchain according to the smart contract and the rules that control access to the stored consideration within the contract wallet. The withdrawal may be initiated by the system (e.g., a third party platform).

Request component 108 may be configured to receive a user request to create a user account. The user request may include user information for establishing a contract wallet associated with the user that includes a smart contract and stored consideration. In some implementations system 100 may interface with one or more other third-party contract wallets such that the user request includes information for establishing an association and/or connection between an existing contract wallet and the system (e.g., the system provider). The user information may include one or more private keys associated with a value of cryptocurrency to be stored by the contract wallet. By way of non-limiting example, the spending mode may include one or more of single asset spending, multi asset spending, portfolio spending, tax neutral spending, price slippage limit spending, investment basket spending, and/or liquid assets spending, such that a transaction involving the contract wallet is made according to the spending mode indicated by the rules.

Contract wallet component 110 may be configured to generate a full private key for the user account that facilitates access to first level options for the contract wallet and/or the stored consideration within the contract wallet. Facilitating access to the first level options and/or to limited options for the contract wallet may include providing an user interface for receiving input related to the first level options and/or the limited options.

User interface component 122 may be configured to receive user input defining rules for a smart contract that control the system's access to the stored consideration within the contract wallet. The rules that may control access to the stored consideration further include rules that control a spending mode for the stored consideration within the contract wallet. By way of non-limiting example, the rules further control the users and/or one or more other users' access to the stored consideration, such that the rules may include one or more of a user withdrawal limit, an emergency drain, a whitelist of potential destinations to which a withdrawal may be directed, an inactivity drain, and/or a card block.

User interface component 122 may be configured to receive user input requesting one or more additional full private keys and/or one or more limited private keys. The one or more limited private keys may facilitate access to limited options for the contract wallet. By way of non-limiting example, the limited options may include one or more of withdrawing, spending, transferring, and/or selling the stored consideration, initiating an emergency drain of the stored consideration, and/or monitoring transactions associated with the contract wallet.

Contract wallet component 110 may be configured to generate a smart contract on the blockchain between the user and the system based on the user input defining the rules. Contract wallet component 110 may be configured to generate a contract wallet including the smart contract. The smart contract may govern the limited access to the stored consideration within the contract wallet associated with the user by the system.

The smart contract may be generated by contract wallet component 110 responsive to a user request to create a user account. Generating the smart contract on the blockchain between the user and the system may include creating a new a smart contract (e.g., creating a smart contract from scratch) based on the user input defining the rules, obtaining a smart contract and/or modifying the smart contract based on the user input defining rules, and/or otherwise generating a smart contract based on the user input. The smart contract may be obtained from one or more of electronic storage 126, external resources 124, client computing platform(s) 104, and/or other sources. By way of non-limiting example, contract wallet component 110 may be configured to obtain the smart contract and/or modify the smart contract on the blockchain based on the user input defining the rules that control the system's access to the stored consideration within the contract wallet.

In some implementations, server(s) 102, client computing platform(s) 104, and/or external resources 124 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 124 may be operatively linked via some other communication media.

A given client computing platform 104 may include one or more processors configured to execute computer program components. The computer program components may be configured to enable an expert or user associated with the given client computing platform 104 to interface with system 100 and/or external resources 124, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 124 may include sources of information outside of system 100, external entities participating with system 100, and/or other resources. In some implementations, some or all of the functionality attributed herein to external resources 124 may be provided by resources included in system 100.

Server(s) 102 may include electronic storage 126, one or more processors 128, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 126 may comprise non-transitory storage media that electronically stores information. The electronic storage media of electronic storage 126 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 126 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 126 may include one or more virtual storage resources (e.g., cloud storage, a virtual private network, and/or other virtual storage resources). Electronic storage 126 may store software algorithms, information determined by processor(s) 128, information received from server(s) 102, information received from client computing platform(s) 104, and/or other information that enables server(s) 102 to function as described herein.

Processor(s) 128 may be configured to provide information processing capabilities in server(s) 102. As such, processor(s) 128 may include one or more of a digital processor, an analog processor, a digital circuit designed to process information, an analog circuit designed to process information, a state machine, and/or other mechanisms for electronically processing information. Although processor(s) 128 is shown in FIG. 1 as a single entity, this is for illustrative purposes only. In some implementations, processor(s) 128 may include a plurality of processing units. These processing units may be physically located within the same device, or processor(s) 128 may represent processing functionality of a plurality of devices operating in coordination. Processor(s) 128 may be configured to execute components 108, 110, 112, 114, 116, 118, 120, 122, and/or other components. Processor(s) 128 may be configured to execute components 108, 110, 112, 114, 116, 118, 120, 122, and/or other components by software; hardware; firmware; some combination of software, hardware, and/or firmware; and/or other mechanisms for configuring processing capabilities on processor(s) 128. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, 118, 120, and 122 are illustrated in FIG. 1 as being implemented within a single processing unit, in implementations in which processor(s) 128 includes multiple processing units, one or more of components 108, 110, 112, 114, 116, 118, 120, and/or 122 may be implemented remotely from the other components.

While computer program components are described herein as being implemented via processor(s) 128 through machine readable instructions 106, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different components 108, 110, 112, 114, 116, 118, 120, and/or 122 described below is for illustrative purposes, and is not intended to be limiting, as any of components 108, 110, 112, 114, 116, 118, 120, and/or 122 may provide more or less functionality than is described. For example, one or more of components 108, 110, 112, 114, 116, 118, 120, and/or 122 may be eliminated, and some or all of its functionality may be provided by other ones of components 108, 110, 112, 114, 116, 118, 120, and/or 122. As another example, processor(s) 128 may be configured to execute one or more additional components that may perform some or all of the functionality attributed below to one of components 108, 110, 112, 114, 116, 118, 120, and/or 122.

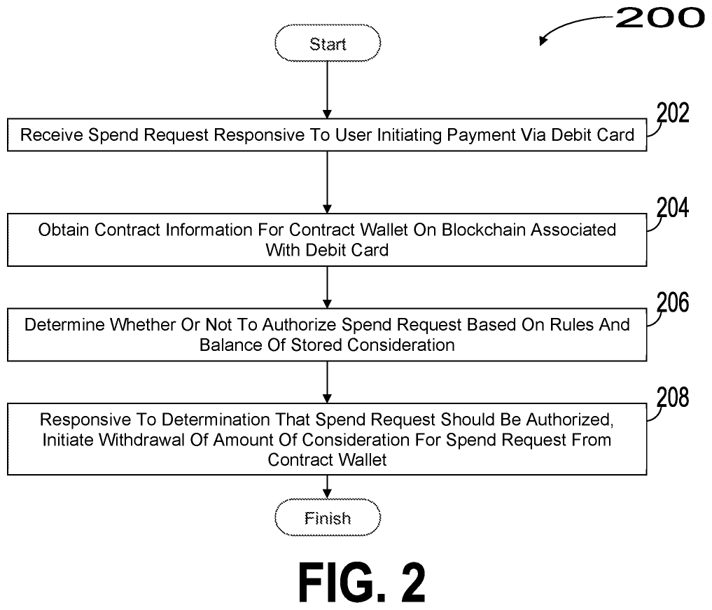

FIG. 2 illustrates a method 200 for receiving and distributing consideration via smart contracts on a blockchain, the method being implemented by a computer system including one or more processors configured by machine-readable instructions, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include receiving a spend request responsive to a user initiating payment via a debit card. The spend request may include an amount of consideration to be spent, a type of the consideration to be spent, and a card identifier identifying the debit card and a contract wallet on the blockchain associated with the debit card. The contract wallet may include stored consideration and a smart contract having rules that control access to the stored consideration. Operation 202 may be performed by one or more hardware processors configured by machine-readable instructions including a component that is the same as or similar to request component 108, in accordance with one or more implementations.

An operation 204 may include obtaining contract information for the contract wallet on the blockchain associated with the debit card. The contract information may include the rules that control the access to the stored consideration included in the contract wallet, and a balance of the stored consideration within the contract wallet. Operation 204 may be performed by one or more hardware processors configured by machine-readable instructions including a component that is the same as or similar to contract wallet component 110, in accordance with one or more implementations.

An operation 206 may include determining whether or not to authorize the spend request based on the rules and the balance of the stored consideration. Operation 206 may be performed by one or more hardware processors configured by machine-readable instructions including a component that is the same as or similar to authorization component 112, in accordance with one or more implementations.

An operation 208 may include, responsive to a determination that the spend request should be authorized, initiating a withdrawal of the amount of consideration for the spend request from the contract wallet. Operation 208 may be performed by one or more hardware processors configured by machine-readable instructions including a component that is the same as or similar to withdrawal component 116, in accordance with one or more implementations.

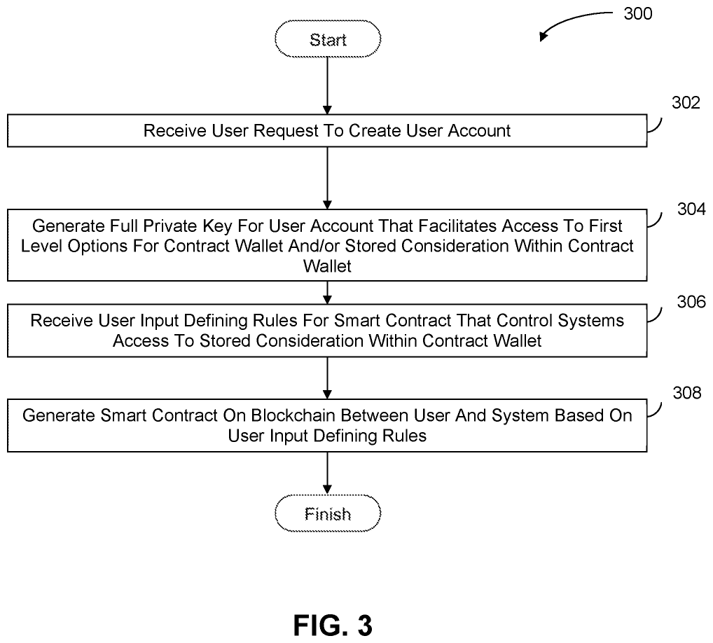

FIG. 3 illustrates a method 300 for providing limited access to stored consideration within contract wallets associated with users via smart contracts on a blockchain, the method being implemented via one or more physical processors configured by machine-readable instructions, in accordance with one or more implementations. The operations of method 300 presented below are intended to be illustrative. In some implementations, method 300 may be accomplished with one or more additional operations not described, and/or without one or more of the operations discussed. Additionally, the order in which the operations of method 300 are illustrated in FIG. 3 and described below is not intended to be limiting.

In some implementations, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include receiving a user request to create a user account. The user request may include user information for establishing a contract wallet associated with the user that includes a smart contract and stored consideration. Operation 302 may be performed by one or more hardware processors configured by machine-readable instructions including a component that is the same as or similar to a request component 106, in accordance with one or more implementations.

An operation 304 may include generating a full private key for the user account that facilitates access to first level options for the contract wallet and/or the stored consideration within the contract wallet. Operation 304 may be performed by one or more hardware processors configured by machine-readable instructions including a component that is the same as or similar to contract wallet component 110, in accordance with one or more implementations.

An operation 306 may include receiving user input defining rules for a smart contract that control the system's access to the stored consideration within the contract wallet. Operation 306 may be performed by one or more hardware processors configured by machine-readable instructions including a component that is the same as or similar to user interface component 122, in accordance with one or more implementations.

An operation 308 may include generating a smart contract on the blockchain between the user and the system based on the user input defining the rules. The smart contract may govern the limited access to the stored consideration within the contract wallet associated with the user by the system. Operation 308 may be performed by one or more hardware processors configured by machine-readable instructions including a component that is the same as or similar to contract wallet component 110, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for providing limited access to stored consideration within contract wallets associated with users via smart contracts on a blockchain, the method being implemented via one or more physical processors configured by machine-readable instructions, the system comprising:
one or more hardware processors configured by machine-readable instructions to:
receive a user request to create a user account, the user request including user information to establish a contract wallet associated with the user that includes a smart contract and stored consideration;
generate a full private key for the user account that facilitates access to first level options for the contract wallet and/or the stored consideration within the contract wallet;
receive user input defining rules for a smart contract that control a system provider's access to the stored consideration within the contract wallet; and
generate a smart contract on the blockchain between the user and the third party platform based on the user input defining the rules, wherein the smart contract governs the limited access to the stored consideration within the contract wallet associated with the user by the system provider, and
facilitate a withdraw initiated by the system provider of an amount of consideration from the contract wallet.

2. The system of claim 1, wherein facilitating access to the first level options and/or to limited options for the contract wallet includes providing a user interface for receiving input related to the first level options and/or the limited options.

3. The system of claim 1, wherein the one or more hardware processors are further configured by machine-readable instructions to receive user input requesting one or more additional full private keys and/or one or more limited private keys.

4. The system of claim 1, wherein the one or more limited private keys facilitate access to limited options for the contract wallet, wherein the limited options include one or more of:
withdrawing, spending, transferring, and/or selling the stored consideration,
initiating an emergency drain of the stored consideration, and/or
monitoring transactions associated with the contract wallet.

5. The system of claim 1, wherein the rules that control access to the stored consideration further include rules that control a spending mode for the stored consideration within the contract wallet.

6. The system of claim 1, wherein the rules further control the users and/or one or more other users access to the stored consideration, such that the rules include one or more of a user withdrawal limit, an emergency drain, an inactivity drain, and/or a card block.

7. The system of claim 1, wherein generating the smart contract on the blockchain between the user and the third party platform based on the user input defining the rules includes obtaining a smart contract and modifying the smart contract based on the user input defining the rules.

8. The system of claim 1, wherein generating the smart contract on the blockchain between the user and the third party platform based on the user input defining the rules includes creating a new smart contract based on the user input defining the rules.

9. A method for providing limited access to stored consideration within contract wallets associated with users via smart contracts on a blockchain, the method being implemented via one or more physical processors configured by machine-readable instructions, the method comprising:
receiving a user request to create a user account, the user request including user information to establish a contract wallet associated with the user that includes a smart contract and stored consideration;
generating a full private key for the user account that facilitates access to first level options for the contract wallet and/or the stored consideration within the contract wallet;
receiving user input defining rules for a smart contract that control a system provider's access to the stored consideration within the contract wallet; and
generating a smart contract on the blockchain between the user and the third party platform based on the user input defining the rules, wherein the smart contract governs the limited access to the stored consideration within the contract wallet associated with the user by the system provider, and
facilitating a withdraw initiated by the system provider of an amount of consideration from the contract wallet.

10. The method of claim 9, wherein facilitating access to the first level options and/or to limited options for the contract wallet includes providing an user interface for receiving input related to the first level options and/or the limited options.

11. The method of claim 9, further comprising receiving user input requesting one or more additional full private keys and/or one or more limited private keys.

12. The method of claim 11, wherein the one or more limited private keys facilitate access to limited options for the contract wallet, the limited options including one or more of withdrawing, spending, transferring, and/or selling the stored consideration, initiating an emergency drain of the stored consideration, and/or monitoring transactions associated with the contract wallet.

13. The method of claim 11, wherein the rules that control access to the stored consideration further include rules that control a spending mode for the stored consideration within the contract wallet.

14. The method of claim 11, wherein the rules further control the users and/or one or more other users access to the stored consideration, such that the rules include one or more of a user withdrawal limit, an emergency drain, an inactivity drain, and/or a card block.

15. The method of claim 9, wherein generating the smart contract on the blockchain between the user and the third party platform based on the user input defining the rules includes obtaining a smart contract and modifying the smart contract based on the user input defining rules.

16. The method of claim 9, wherein generating the smart contract on the blockchain between the user and the third party platform based on the user input defining the rules includes creating a new smart contract based on the user input defining the rules.
